(19) United States
(12) Patent Application Publication
(10) Pub. No.: US 2019/0012606 A1
(43) Pub. Date: Jan. 10, 2019

(54) FREIGHT AND WEATHER DECISION SUPPORT SYSTEM

(71) Applicant: University of Iowa Research Foundation, Iowa City, IA (US)

(72) Inventors: Wilfrid A. Nixon, Iowa City, IA (US); Anissa Jensen Gerard, West Branch, IA (US)

(73) Assignee: University of Iowa Research Foundation, Iowa City, IA (US)

(21) Appl. No.: 16/125,031

(22) Filed: Sep. 7, 2018

Related U.S. Application Data
(63) Continuation of application No. PCT/US17/20965, filed on Mar. 6, 2017.
(60) Provisional application No. 62/304,913, filed on Mar. 7, 2016.

(51) Int. Cl. G06N 5/04; G08G 1/0967; G06N 7/00; G05D 1/00; G05D 1/02

(52) U.S. Cl. CPC G06N 5/045; G08G 1/0967; G05D 2201/0213; G05D 1/0088; G05D 1/0214; G06N 7/005

(57) ABSTRACT

A includes receiving data input from a plurality of sources wherein the data input comprises weather data and route data for a vehicle, applying the data input within a decision support system implemented by a computing system to determine an evidence-based probability of risk of delay and crash for the vehicle, and communicating the probability of risk of delay and crash or a decision based on the evidence-based probability of risk of delay and crash to the vehicle or a driver of the vehicle.

### PRIORITY STATEMENT

This application is a continuation of PCT/US2017/020965, filed Mar. 6, 2017, which claims priority to U.S. Provisional Patent Application No. 62/304,913, filed Mar. 7, 2016, both of which are hereby incorporated by reference in their entireties.

### FIELD OF THE INVENTION

The present invention relates to transportation engineering. More particularly, but not exclusively, the present invention relates to a freight and weather decision support system.

### BACKGROUND

During inclement weather, studies show that financial loss to the trucking industry associated with delay is over $9 billion dollars annually. There is additional loss due to crashes associated with inclement weather including nearly 4000 fatalities and 104,000 injuries in 2012. Inclement weather can include snow, rain/thunderstorms, wind, ice, visibility issues and many others. With the advancement of automated vehicles, the decision during inclement weather of whether to stop or continue on has significant impacts.

Conventionally, decisions during inclement weather are typically made by the individual driver. There are many aspects of bias including length of time driving trucks and past experiences. What is needed is a method, system, or apparatus for assisting truck drivers or otherwise making decisions regarding whether and/or when to stop or continue.

### SUMMARY

Therefore, it is a primary object, feature, or advantage of the present invention to improve over the state of the art.

It is a further object, feature, or advantage of the present invention to assist truck drivers in making a decision as to whether to stop or continue during inclement weather.

It is a still further object, feature, or advantage of the present invention to assist automated vehicles in making a decision as to whether to stop or continue during inclement weather.

Another object, feature, or advantage is to use a decision support system to assign a risk of delay or crash.

Yet another object, feature, or advantage is to use a Bayesian Belief Network (BBN) as a decision support system and can assign a risk of delay or crash based on existing data.

A further object, feature, or advantage is to reduce economic costs associated with unnecessary losses during inclement weather including losses to delay and losses due to crashes.

A still further object, feature, or advantage is to improve safety for truck drivers or others traveling in inclement weather.

A still further object, feature, or advantage is to provide a method and system which may be used for human-operated vehicles, autonomous vehicles, and connected or convoyed vehicles.

Another object, feature, or advantage is to provide a method and system that allows for a variety of different types of weather data to be used from a variety of different sources.

One or more of these and/or other objects, features, or advantages of the present invention will become apparent from the specification and claims that follow. No single embodiment need provide each and every object, feature, or advantage. Different embodiments may have different objects, features, or advantages. Therefore, the present invention is not to be limited to or by an objects, features, or advantages stated herein.

According to one aspect, a method includes receiving data input from a plurality of sources wherein the data input comprises weather data and route data for a vehicle, applying the data input within a decision support system implemented by a computing system to determine a probability of risk of delay and crash for the vehicle, and communicating the probability of risk of delay and crash or a decision based on the probability of risk of delay and crash to the vehicle or a driver of the vehicle. The decision support system may include a Bayesian Belief Network. The weather data may be weather forecast data. The vehicle may be a freight carrying vehicle such as a truck. The vehicle may be an autonomous vehicle and may be a vehicle within a convoy. The decision may be selected from a set consisting of stop now, stop soon, possible stop, drive through or re-route.

According to another aspect, an apparatus includes instructions stored on a machine readable memory of a computing device for (a) receiving data input from a plurality of sources wherein the data input comprises weather data and route data for a vehicle, (b) applying the data input within a decision support system to determine an evidence-based probability of risk of delay and crash for the vehicle, and (c) communicating the probability of risk of delay and crash or a decision based on the evidence-based probability of risk of delay and crash to the vehicle or a driver of the vehicle. The apparatus may further include a display for use within the vehicle and wherein the communicating includes displaying on the display. The apparatus may further include an interface for communicating with the vehicle. The apparatus may be a standalone system, integrated with other after market devices, or may be integrated into the vehicle. The decision support system may be implemented by the computing device or may be implemented at a server platform which is in operative communication with the computing device.

### BRIEF DESCRIPTION OF THE DRAWINGS

FIG. 1 illustrates an overview of one embodiment.

FIG. 2 further illustrates the Bayesian Belief Network of FIG. 1.

FIG. 3 is one example of a method.

FIG. 4 is illustrates another example of a Bayesian Belief Network.

FIG. 5 illustrates one example of a system for implementing the Bayesian Belief Network.

FIG. 6 illustrates another example of a system for implementing the Bayesian Belief Network.

### DETAILED DESCRIPTION

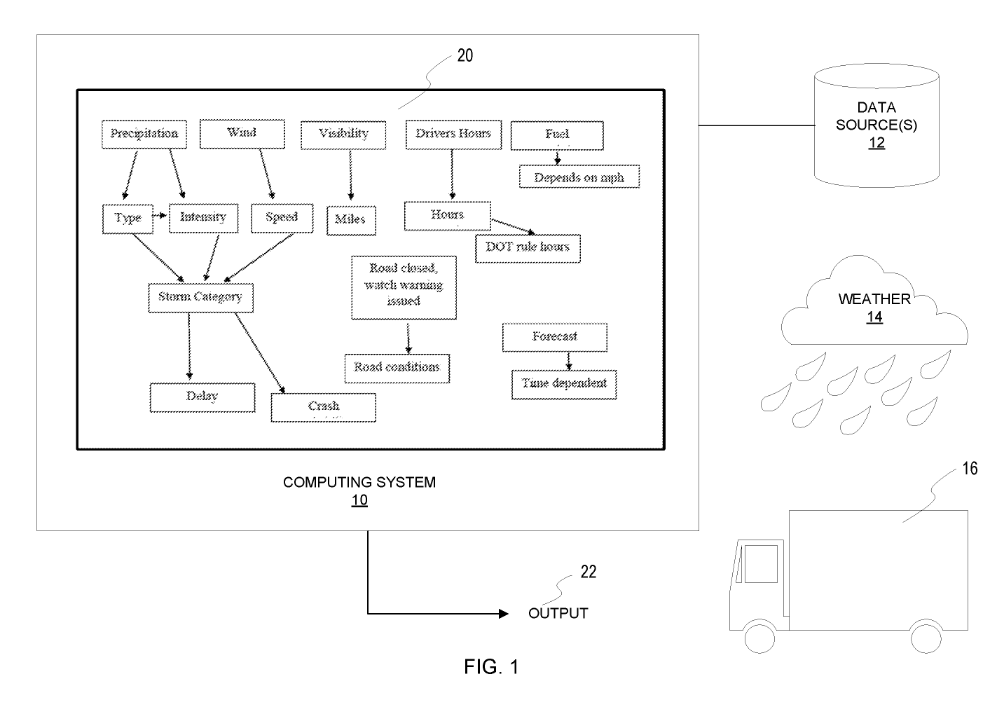

FIG. 1 illustrates one embodiment of the invention. As shown in FIG. 1 there is a computing system 10 which may be programmed to execute a decision support system 20. Data used in the decision support system 20 may come from any number of different data sources 12. The computing system 10 may execute instructions which implement the decision support system 20 in order to provide output 22 which is used in making a decision associated with the operation of a vehicle 16 in view of inclement weather 14. Examples of such decisions may include, without limitation, the decision to stop now, stop soon, possible stop, drive through, or re-route.

The decision support system 20 shown includes a Bayesian Belief Network. However, any number of different types of decision support systems and models may be used. One benefit of using a Bayesian Belief Network is that some of the input may be subjective in nature. The decision support system 20 may be used to provide output 22 in the form of a probability of risk of delay and crash. The output 22 may then be communicated to a vehicle operator such as a truck driver either directly or indirectly or to a vehicle itself either directly or indirectly.

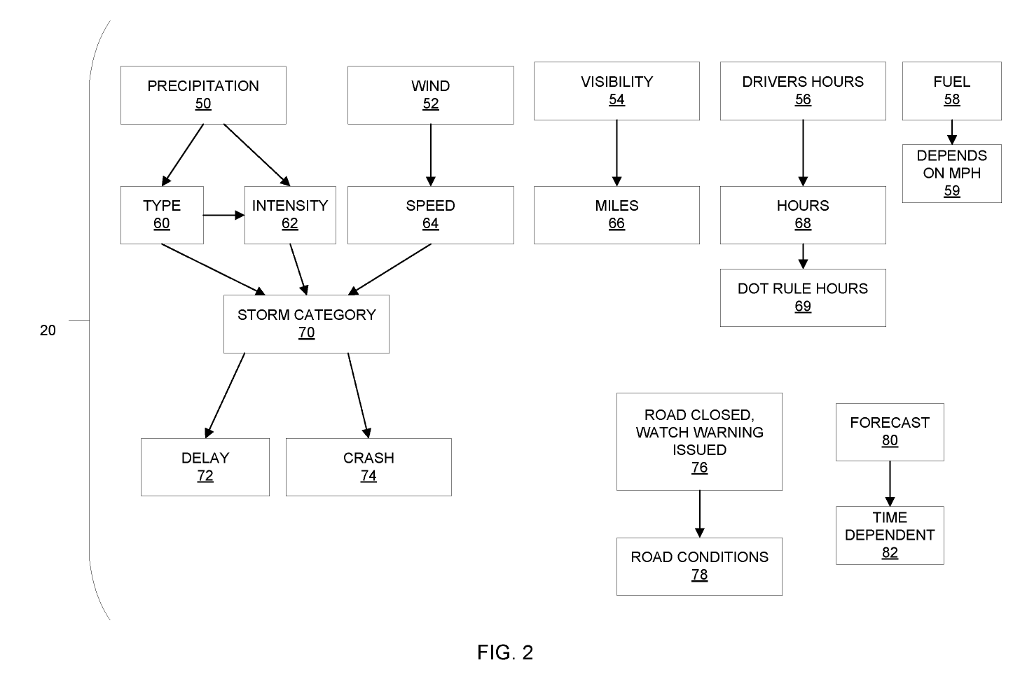

The Bayesian Belief Network (BBN) may use a combination of conditional probability tables (CPT) to determine the output from the network. FIG. 2 illustrates the decision support system of FIG. 1 in greater detail. As shown in FIG. 2 various storm parameters may be used such as precipitation 50, wind 52, and visibility 54 of which one characteristic is miles 66. Road closures and warnings 76 and road conditions 78, drivers' hours 56 (and hours 68 and Department of Transportation or other regulatory rule hours 69) and fuel remaining 58 (which may depend on miles per hour 59) may also be important parameters in the final decision but as shown in FIG. 1 and FIG. 2 were eliminated from the BBN due to the influence of each on the actual probability of risk of delay and crash. Of course, in other implementations these parameters may be used. Forecast information 80 which may be time dependent 82 may also be used as an input. Forecast accuracy may have an effect on the results also but is not directly linked to the probability of risk of delay 72 and crash 74. This was included into the BBN to define the accuracy of the forecast as a function of storm category 70. Storms may be categorized into different types such as winter/snow, rain/thunderstorm, and wind. Storms may be categorized based on precipitation type 60 and intensity 62, wind characteristics 52 such as wind speed 64, or other variables. Storms may be categorized by the decision support system. Storms may be categorized using discrete variables or storms may be categorized using one or more continuous variables. In addition, various parameters for the storms may be used. Examples of possible parameters include wind, rain, snow, ice, and visibility.

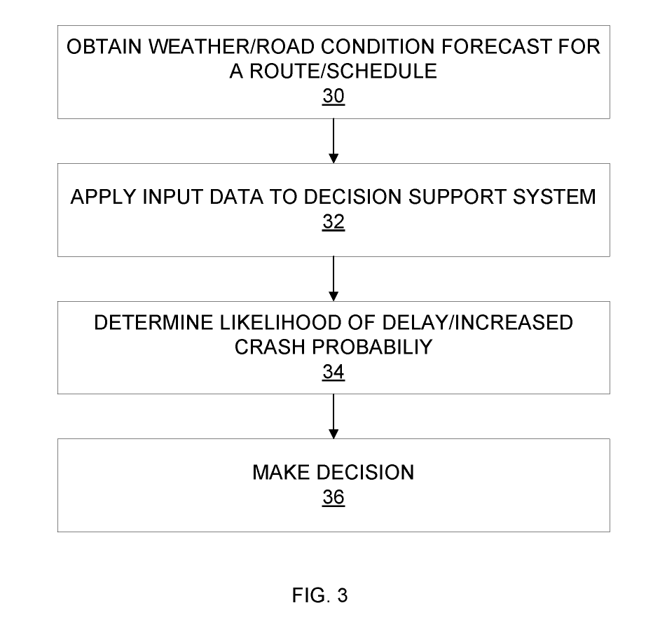

FIG. 3 illustrates one example of a methodology. In step 30, weather forecast information and/or road condition forecast information for a particular route and schedule is provided. In step 32, this input data is applied to a decision support system. In step 34 a determination is made as to the likelihood of delay and/or the increased crash probability associated with weather conditions. In step 36 a decision may be made based at least in part on the probabilities determined in step 34.

### Overview of BBN Example

To develop a decision support system (DSS) for freight and weather, numerous types of systems may be used. A freight and weather DSS can have many variables but is contingent on the weather forecast. The weather forecast itself has uncertainty associated with it and that accuracy is time dependent prior to the weather event. Because the uncertainty is unknown and a Bayesian Belief Network (BBN) can take into account both actual evidence and uncertainty, a BBN was chosen as the preferred mechanism to perform the decision support. However, any number of other types of models or algorithms may be used including, without limitation, neural networks, fuzzy logic systems, neuro-fuzzy systems, genetic algorithms, heuristics, and expert systems.

The fundamental idea behind the DSS is that a weather forecast/occurring storm conditions may be used as input into the system. The BBN may then take the forecast/weather conditions, and use them to determine the likelihood of a delay on a given trip, and the likelihood of increased crash probability, also on the given trip. Then, on the basis of those two outputs, a decision may be made about the upcoming trip. Should it be delayed, or started sooner, or perhaps rerouted altogether. One step in developing such a system is to compare the decisions from the DSS with naturalistic decisions made by truck drivers. One way to obtain the naturalistic decisions made by truck drivers is via survey. Thus, decisions from the system and methods may be used to develop an action decision which may be compared to the results of the survey.

The weather data is used to test the BBN and provide a probability of risk of delay and crash. The results for each of the six storms and scenarios were used to develop an action decision. These decisions were then compared to the results of the survey of the truck drivers.

Investigating past research on categorizing storms was completed to determine the best way to assess a particular weather event. A discrete categorization of any weather event was selected to enhance the usefulness of the proposed system to freight. Categorizing a storm using discrete variables simplifies the Bayesian Belief Network, however, it is contemplated that a continuous variable may alternatively be used for storm categories that are specific to freight.

### Storm Category Development

The storm category was determined to be used as four discrete categories; 0, 1, 2, 3. This was determined to be sufficient with the descriptions for each of the four as none, light, moderate and heavy. For each storm parameter: rain, snow, ice, wind and visibility, and a value was assigned for each of the four categories. Five different parameters from the storms were selected for analysis, namely, wind, rain, snow, ice and visibility. For each of these parameters an associated level was determined as shown in the below tables with the first table being qualitative and the second table providing numerical values.

| STORM | Wind | | | | Visibility |
|---|---|---|---|---|---|
| CATEGORY | (mph) | Rain | Snow | Ice | (mi) |
| 0 | Light | NONE | NONE | NONE | High |
| 1 | Moderate | Light | Light | Moderate | Near high |
| | | | | Snow | |
| 2 | Heavy | Moderate | Moderate | Heavy | Medium |
| | | | | Snow | |
| 3 | Extreme | Heavy | Heavy | Heavy | Low |
| | | | | snow | |
| STORM | Wind | Rain | Snow | | Visibility |
| CATEGORY | (mph) | (in/hr) | (in/hr) | Ice(in) | (mi) |
| 0 | <15 | NONE | NONE | NONE | >2 |
| 1 | 16-25 | 0-0.01 | 0-0.1 | | 1-2 |
| 2 | 26-35 | 0.01-0.3 | 0.11-0.5 | | 0.5-1 |
| 3 | >35 | >0.3 | >0.5 | | <0.25 |

### Storm Scenarios

For six historical storms, five truck delivery scenarios were chosen for rain and snow storms and three truck delivery scenarios were chosen for severe wind conditions. Actual data for existing delays and crash rates for storms and weather parameters for freight specifically were collected.

### Bayesian Belief Network Development

A Bayesian Belief Network is a graphical representation of a model using evidence based probabilities and uncertainties to form a decision support system. It is one of many methods of DSS but was chosen due the ability to combine probabilities and also account for uncertainties such as with the forecast.

In creating the network in the software Bnet.builder, parent and child nodes are identified as information for the decision support system. This allows each of the nodes to be either nodes where information is known about them or nodes for output probabilities. Each node can be a child node, parent node or both. The nodes are precipitation, the type, and amount of precipitation, wind and speed, and visibility and distance. Each of the child nodes feeds into a parent node, which for the aforementioned nodes is the storm category node. The storm category is a child node for the crash probability and the delay probability which are the parent nodes and desired information. The storm category node is also a child node that feeds into the forecast skill. The diagram of the parent-child nodal system from the Bnet.builder software is shown below in FIG. 3. Although this particular software was used in this example, it is to be understood that any number of other software applications may be used, the model may be otherwise implemented in software or hardware.

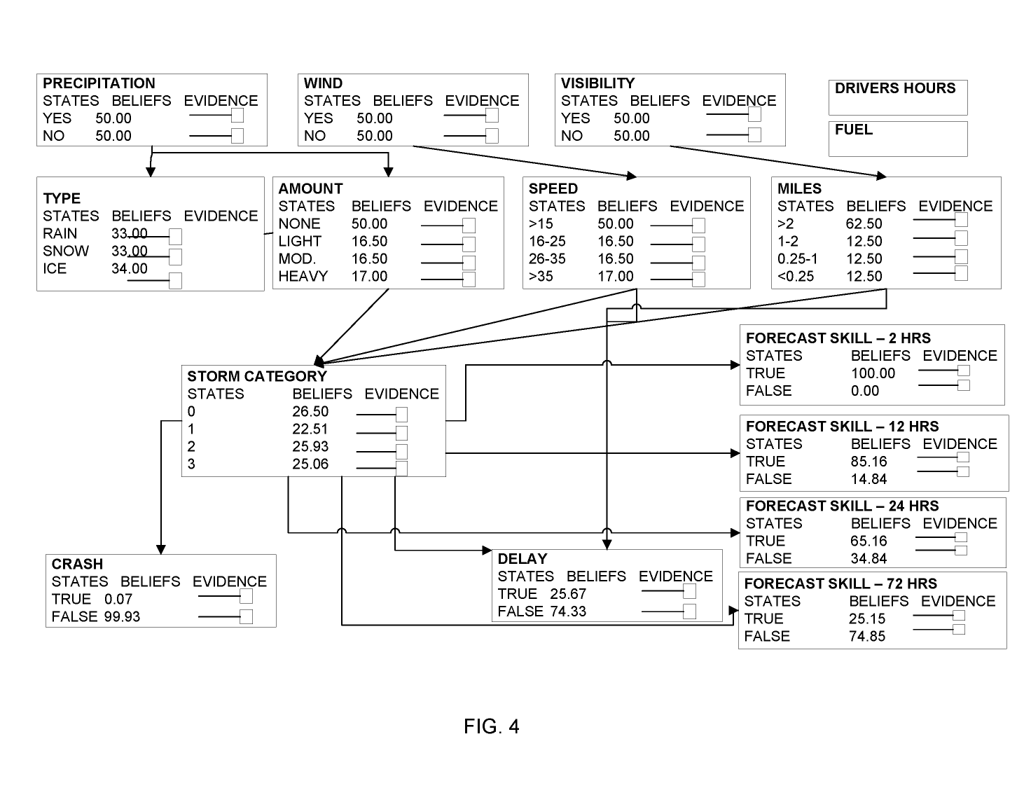

In FIG. 4, one example of a complete network implemented in the software is shown. This shows each node and how they feed into each other using a link with an arrow. The precipitation, wind and visibility all feed into the storm category node. The storm category node feeds into the crash and delay node. For delay the wind and visibility also feed into the delay node in order to take into account the combined probabilities for all weather parameters. The storm category node also feeds into the forecast skill nodes but again these are only based on hypothesized accuracy.

The forecast skill node was added. This is a node that storm category feeds into. It would be desirable to use actual probabilities of accuracy of the forecast. Nodes for remaining fuel and drivers hours were also included but not connected to the system. It was determined that including this in a discrete model was not going to affect the delay or crash probability. These will, however, affect the outcome decision which are assigned as a result of the output of the BBN

These were transformed into a probability for each storm category. Once the evidence of storm parameters are input into the model, the BBN assigns a probability of the category of the storm. The Bayesian Belief Network then applies the calculated risk associated with each category for evidence-based delay and crash.

The conditional probability tables for delay are separate for rain, snow and ice. This is because the delay based on speed reduction is different for rain, snow, ice, wind and visibility. These are changed in the BBN for each of the different types of storms scenario runs. The probabilities are added together for precipitation type, wind and visibility percentage of delay based on speed reduction when more than one of these conditions is present in a storm. However, the combination of probabilities need not be treated as simply additive and other approaches may be used.

### Probability Determination

A BBN, as discussed previously, uses a combination of conditional probability tables (CPT) to determine the output from the network. Each node has an associated CPT. To determine the necessary probabilities for the table, the main categories of risk are delay and crash. Under each are the five storm conditions that affect freight travel; snow, rain, ice, wind, and visibility. Each has a level associated with the storm categories 0, 1, 2, and 3.

For delay, the probabilities are presented in terms of a reduced speed. Thus a delay probability of 10% in this context means that the average speed is reduced by 10% from normal speed values. As noted above, for each of the weather types considered herein (rain, snow, wind, and reduced visibility) four levels of severity were defined—0 (no event), 1, 2, and 3. The below table illustrates one example of delay for each weather type and each severity level. The delay may also be expressed in terms of speed reduction in miles per hour.

| PERCENTAGE | | | | | |
|---|---|---|---|---|---|
| PROBABILITY | | | | | |
| OF DELAY(%) | Wind | Rain | Snow | Ice | Visibility |
| 0 | 0 | 0 | 0 | 0 | 0 |
| 1 | 2 | 5 | 5 | 22 | 18 |
| 2 | 2 | 22 | 22 | 79 | 22 |
| 3 | 4 | 36 | 79 | 79 | 22 |

The determination of the probabilities of delay may be made in various ways, through available data and appropriate assumptions and applying appropriate statistical or other analytical tools. The present invention is not to be limited to the specific methods employed.

Crash probabilities may also be determined in various ways through available data and appropriate assumptions and applying appropriate statistical or other analytical tools. The present invention is not to be limited to the specific methods employed. The below table illustrates one calculation of crash probabilities derived from truck crash raters per mile traveled in different weather types.

| | | | Normal | | | Normal | | | Normal | | | Normal |
|---|---|---|---|---|---|---|---|---|---|---|---|---|
| | | | driving | | | driving | | | driving | | | driving |
| | | | conditions | | | conditions | | | conditions | | | conditions |
| | | Crash | crash | | Crash | crash | | Crash | crash | | Crash | crash |
| | Storm 1 | probability | probability | Storm 2 | probability | proba | Storm 5 | probability | probability | Storm 6 | probability | probability |
| Scenario 1 | 468 | 0.1281 | 0.0124 | 1003 | 0.2746 | 0.0265 | 298 | 0.0196 | 0.0079 | 991 | 0.0653 | 0.0262 |
| Scenario 2 | 178 | 0.0487 | 0.0047 | 440 | 0.1205 | 0.0116 | 285 | 0.0188 | 0.0075 | 1444 | 0.0951 | 0.0381 |
| Scenario 3 | 308 | 0.0843 | 0.0081 | 468 | 0.1281 | 0.0124 | 600 | 0.0395 | 0.0158 | 712 | 0.0469 | 0.0188 |
| Scenario 4 | 295 | 0.0808 | 0.0078 | 595 | 0.1629 | 0.0157 | 252 | 0.0166 | 0.0067 | 1625 | 0.1070 | 0.0429 |
| Scenario 5 | 305 | 0.0835 | 0.0081 | 350 | 0.0958 | 0.0092 | 1102 | 0.0726 | 0.0291 | 588 | 0.0387 | 0.0155 |

Once these percentages of probability of risk of delay and crash were calculated by the network, the output was produced. An assessment was done to determine which actions should be associated with a particular range of probability risk of delay and crash. These actions decisions were determined to be delay the trip, stop immediately, stop later, drive through the storm or re-route.

### Survey

To determine the efficacy of some of the assumptions in the FWDSS, a truck driver survey was developed. This allows a comparison of the naturalistic decision (truck driver) to the assigned decision based on existing probability data from the BBN. Thus, data from decisions made using the FW DSS was compared to the output of the surveys conducted with truck driver assess a ranking on the severity of the storms and to determine which decision they would make in terms of driving through the storm, stopping and if so at what point or delaying the trip.

### Results

Various storm scenario runs were input and the resulting BBN output showed a storm category, probability risk of delay and crash and accuracy of the forecast skill for each of the storm scenarios.

The BBN output resulted in a storm category, probability risk of delay and crash and accuracy of the forecast skill for each of the 26 scenarios. In order to develop a decision based on the results, the output for probability of delay and crash were then modified to determine an index ranged between 0 and 10 based on the geometric mean. This allows a decision to be based on a combination of the results showing the collective risk. The index was then used to develop a decision matrix for a range of indexes within 0-10. Based on the results of the indexes for each storm scenario, a preliminary decision is assigned for a range of values. The options chosen for action decisions are: stop now, stop soon, possible stop and drive through. The final decision based on indexes is shown below.

| RANGE OF | |
|---|---|
| INDEXES | DECISION |
| 8.5-10 | STOP NOW |
| 6-8.5 | STOP SOON |
| 2-6 | POSSIBLE STOP |
| 0-2 | DRIVE THROUGH |

This decision may be supplemented with drivers hours remaining, fuel remaining, and severity and track of the weather event. There is a chance stopping is not the best decision if one is ahead of the storm.

The results obtained show that it is possible to quantify in a meaningful way the increased risks of crash and delay for freight traffic as a result of inclement weather. This will lead us to safer, more mobile freight during such weather. Further, we have found that the decisions of FWDSS are more robust than naturalistic decisions. Using data from existing literature, we were able to quantify four levels of weather related delay for different storm parameters. Also, we found crash rate data and determined the probability of a crash in terms of truck miles traveled.

Being able to quantify risk to enhance decision making improves confidence in decisions. The decisions are data driven not experience driven. Using data from existing literature and finding the probability of delay and crash, we have been able to quantify a collective risk. This has not been done previously in this context. The collective risk is finalized into an index between 0-10. This provides a combined risk of delay and crash and can add forecast skill as data become available. The results of FWDSS provide evidence based decisions using a collective risk quantified in terms of delay and crash risk rather than personal experience based decisions.

Using the results of a small survey, we were able to assess the assumptions made with our model and compare those assumptions to those made by truck drivers. The survey shows that drivers claim they will stop or delay during snow and wind storms but not during rain storms. It also shows that if given the knowledge of the probability of delay they will more likely stop sooner than using their own decisions. This shows that drivers' naturalistic decision-making does not evaluate the real risks of crash and delay due to bad weather appropriately.

With the advancement of connected vehicle technology and automated vehicles, FWDSS has the potential to become a critical tool in truck decision making of automated freight vehicles. One of the earliest implementations of automated vehicle technology in the freight arena may be the use of convoying (which has already been demonstrated experimentally on the highway) in which the lead truck in essence controls all the trucks in the convoy (or all the connected vehicles). This means that the decision of one truck then affects all the trucks in the convoy. This could increase the risk of delay and crash by affecting multiple trucks. Using FWDSS can apply a value-added decision to all the trucks and reduce delay and crash during inclement weather events.

In summary, FWDSS provides a value-added decision by using the data available optimally and assigns a decision methodology to reduce crash risk and increase mobility as we move to automated vehicles.

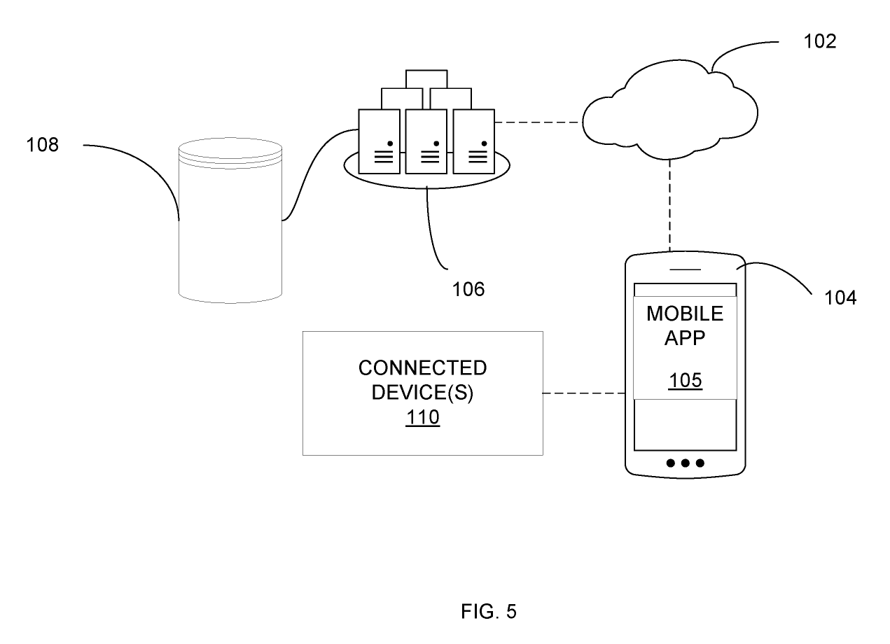

FIG. 5 illustrates one example of an implementation of the system. As shown in FIG. 5, a mobile device 104 is operatively collected through a communications network 102 to a server platform 106. The mobile device 104 may be a phone, tablet, or other mobile device or other type of computing device. A mobile app 105 may be stored in a machine-readable memory of the mobile device 104 and may be executed by a processor of the mobile device 104. The mobile device 104 may include a display for displaying information to a user. The server platform 106 is in operative communication with one or more databases 108 or other data links. The server platform 106 is configured to implement the FWDSS shown and described. Data, including weather data may come from one or more linked sources and be stored in the databases 108. In addition, data may come from users, their vehicles, or other connected devices 110. Thus, for example, data may be collected with one or more sensors of a vehicle, or sensors along a roadway or otherwise. Such data may be communicated to the mobile app 105 executing on the mobile device 104 in various ways including via Bluetooth, Bluetooth Low Energy (BLE), Wi-Fi, or otherwise. Once the data is received it may be communicated to the server platform 106 for performing analysis.

In alternative embodiment, the mobile app 105 may implement the FWDSS. In such an embodiment, the mobile app 104 may receive data communicated from the server platform 106 and/or one or more databases 108 or other data sources. This data may be used as well as other data collected by the mobile device 104 in order to perform the analysis.

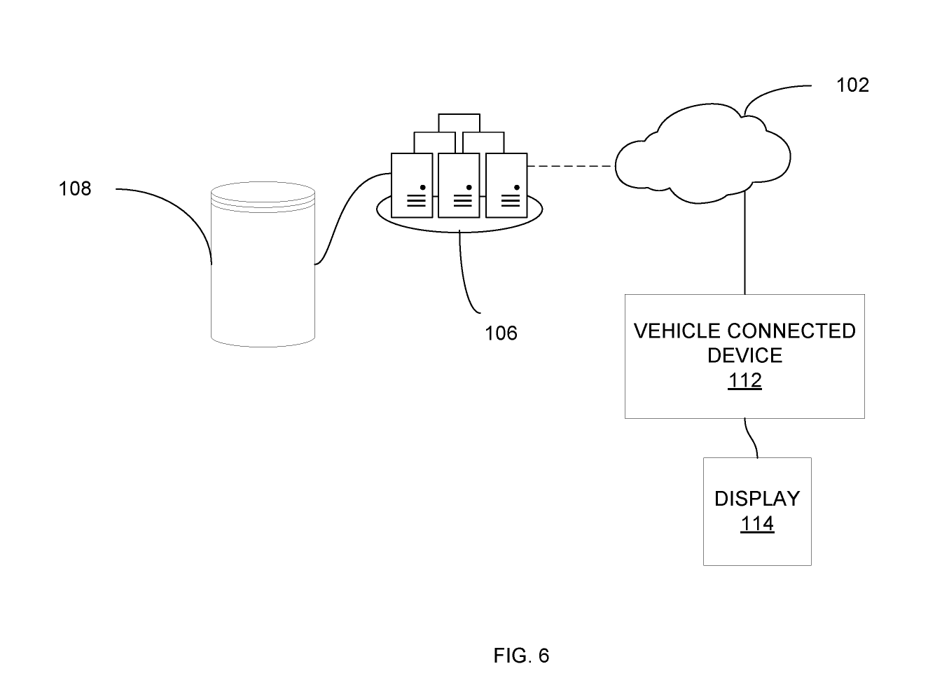

FIG. 6 illustrates another example of an implementation of the system. As shown in FIG. 6, a vehicle connected device 112 is shown. The vehicle connected device 112 has a display 114 associated with it. The vehicle connected device 112 is operatively connected through a communications network 102 to a server platform 106. The vehicle connected device 112 may be a standalone device for implementing the FWDSS, may be integrated into a navigation system or fleet tracking system, may be integrated into an electronic hours of service (HOS) tracking system, or other type of aftermarket system. Alternatively, the vehicle connected device 112 may be integrated into the vehicle itself. Data may be collected from the vehicle connected device 112. For example, where the vehicle connected device 112 has appropriate access, data collected may include temperature data collected from a temperature sensor of the vehicle. Data collected may also include location data such as from a GPS or navigation system of the vehicle. Data collected may also include current state or historical state for windshield wipers for the vehicle, or other information indicative of weather conditions. Data collected may also include the amount of fuel of the vehicle, fuel usage by the vehicle, or other information. Data collected may include hours of service for the driver, or other information. The data collected may then be communicated through the communications network 102 to a server platform 106. The data collected may be stored in one or more databases 108 and combined with other data stored in one or more databases 108 or from other data sources for use in the FWDSS executed by the server platform 106. Alternatively, in some embodiments, the vehicle connected device 112 may include a processor for executing instructions to implement the FWDSS using data from the vehicle connected device 112 and/or data received over the communications network 102 from the server platform 106, one or more databases 108, or other data sources.

### Options, Variations, and Alternatives

Returning to FIG. 1, it is to be further understood that the decision support system 20 may be used in a variety of ways and not merely to determine the probability of delay and crash. For example, the decision support system 20 may calculate the probabilities of delay and crash along a plurality of different routes. Similarly, the decision support system 20 may calculate the probabilities of delay and crash across a plurality of different schedules. Thus, the output 22 from the decision support system 20 may be a set of probabilities for different sets of inputs which may be used not only to determine whether to delay or not but also whether to re-route or not and if so, what particular route or schedule would result in lower probabilities of delay and crash. Thus, more informed decision making may be made to reduce economic loss and improve safety.

According to another the vehicle may be a self-driving vehicle or autonomous vehicle. The self-driving vehicle may be an individual vehicle or may be a part of a convoy or platoon of vehicles. In such instances, the decision support system 20 may take into account the number of vehicles in the convoy and assess the probability of risk of delay and crash for any individual vehicle or the probability of risk of delay and crash for any one or more vehicles within the group. In addition, where the vehicle is self-driving or automated, the vehicle itself may use output from the decision support system to decide whether to stop and delay or re-route. Where the vehicle supports self-driving but an operator is present, the vehicle may take into account the probability of risk of delay and crash both for autonomous operation of the vehicle and for driver operation of the vehicle.

It is further contemplated that the system can use data from any number of different sources to improve the system. For example, it is contemplated that weather information may be collected from individual trucks or truck stops or other locations to provide more accurate information regarding current weather or road conditions or the accuracy of particular forecasts, or actual weather or road conditions during particular crashes in order to further develop or improve the model. Thus, weather information, although it may include information from weather organizations such as the National Oceanic and Atmospheric Administration (NOAA) or the National Weather Service (NWS), may also include meteorologically related sensor readings from other sources, or from sensors embedded in the road surface, from vehicle sensors, or from other types of contact or non-contact sensors.

Weather information may include road weather which includes information specific to the road. For example, road weather may include pavement temperature. It is to be understood that pavement temperature may be different than an ambient temperature and that ambient temperature may not be as reliable as an indicator of road conditions. For example, snow may be falling, but road temperature may be greater. Thus, there would not likely be any ice on the road. Alternatively, if rain is falling but the pavement temperature is 20 degrees Fahrenheit then this may be indicative of ice on the road. In addition to pavement temperature sensors, other types of road weather sensors may also be used. Other examples of such sensors may include a water layer thickness sensor to measure the presence and thickness of water on the road, a chemical sensor to measure levels of chemicals applied to combat freezing of water or snow on the road, a subsurface temperature sensor to measure temperature of a or other types of sensors. Various types of pavement sensors are available from Vaisala Oyj (Vantaa, Finaland). Other types of sensors may also be used including sensors which measure road surface grip (slipperiness of road surface). Such sensors may include non-contact sensors. In some embodiments the sensors may be embedded in the road surface. Any number of different types of sensors are contemplated.

As previously indicated the weather data may include weather data collected from vehicle sensors. It is to be understood that this may include a wide range of different type of data. For example, this may include temperature as measured by an ambient temperature sensor in a vehicle. This may also include other data such as whether or not a vehicle's windshield wipers are turned on or not, or the particular setting at which a vehicle's windshield wipers are set. Although, data such as windshield wiper data is not a direct measurement of weather, it may be interpreted as indicative of weather conditions. For example, if a large percentage of vehicles in a particular area are using their windshield wipers at the same time, it is indicative that there is precipitation in that area.

Thus, it is to be understood that the methods and systems allows for a variety of different types of weather data to be used from a variety of different sources. The particular selection of particular sources of data may be based on the availability of the data, the accuracy or completeness of the data the cost of collecting or distributing the data or other factors.

In addition, it is contemplated that results from the decision support system may be communicated to truck drivers in any number of ways. This may include through a mobile app used by the truck driver which allows the truck driver (or other) to enter a route and schedule and then based on current location and time, weather forecasts, and other available data make decisions. Alternatively, this functionality may be a part of an onboard system such as one which is used for navigation and/or tracking hours of service or other types of regulatory compliance or which provides other forms of fleet management functions. Such a system may be a part of original equipment manufacturer (OEM) trucks or may be installed as aftermarket accessories. Alternatively, this functionality may be performed centrally at a communications center and conveyed to drivers through phone calls, text messages, email, through a vehicle network, or otherwise. Alternatively, thus functionality may be integrated into application such as Google Maps or Bing Maps or other types of mapping or traffic systems. Alternatively, this functionality may be incorporated into products or services which include added value meteorological services so that the decision support system can incorporate the weather forecasting information.

It is contemplated that information may be communicated to drivers in various ways including visually. For example, the information may be projected onto a heads-up type display of the vehicle. The information may be presented on a screen or display device already existing within the vehicle or may be presented on a screen or display of a mobile device or other device which the driver can easily move from vehicle to vehicle if needed. Any number of different manners of display may be used. In addition or instead of visual displays, information may be communicated audibly.

It is also contemplated that significant additions may be made to the model in order to take into account additional data. For example, this may take into account specific information regarding a truck driver including their experience and driving record, a team of truck drivers including their collective experience and driving record, a specific truck including its size and service record, or a specific load including its size or distribution and the effect of delay on the freight being carried. The present invention is not to be limited by the addition of any of this or other data to improve the accuracy of probabilities.

Although emphasis on the disclosure herein has been on freight, it is contemplated that the decision support system may be used in other scenarios where inclement weather has an effect on travel. For example, the system may applied to commuters to assist commuters in making a decision whether to leave early, leave late, or stay home.

Therefore, methods, apparatus and systems have been shown and described for decision support systems to avoid economic losses and/or crashes in inclement weather. Although details of specific embodiments have been shown, the present invention is not to be unduly limited by or to such specific embodiments.

What is claimed is:

1. A method comprising:
receiving data input from a plurality of sources wherein the data input comprises weather data and route data for a vehicle;
applying the data input within a decision support system implemented by a computing system to determine an evidence-based probability of risk of delay and crash for the vehicle; and
communicating the probability of risk of delay and crash or a decision based on the evidence-based probability of risk of delay and crash to the vehicle or a driver of the vehicle.

2. The method of claim 1 wherein the decision support system comprises a Bayesian Belief Network.

3. The method of claim 1 wherein the weather data is weather forecast data.

4. The method of claim 1 wherein the decision support system includes a category of a storm.

5. The method of claim 4 wherein the decision support system further comprises a severity of the storm.

6. The method of claim 1 wherein the vehicle is a freight carrying vehicle.

7. The method of claim 1 wherein the vehicle is a truck.

8. The method of claim 1 wherein the vehicle is an autonomous vehicle.

9. The method of claim 1 wherein the vehicle is a vehicle within a convoy.

10. The method of claim 1 wherein the decision is selected from a set consisting of stop now, stop soon, possible stop, re-route and drive through.

11. The method of claim 1 wherein the communicating is electronically communicating.

12. The method of claim 1 wherein the communicating the probability of risk of delay and crash or the decision based on the probability of risk or delay and crash comprises displaying the probability of risk of delay and crash or the decision based on the probability of risk of delay and crash on a display.

13. The method of claim 1 wherein the vehicle is a commuter vehicle and wherein the driver is a commuter.

14. An apparatus comprising: instructions stored on a machine readable memory of a computing device for (a) receiving data input from a plurality of sources wherein the data input comprises weather data and route data for a vehicle, (b) applying the data input within a decision support system to determine an evidence-based probability of risk of delay and crash for the vehicle, and (c) communicating the probability of risk of delay and crash or a decision based on the evidence-based probability of risk of delay and crash to the vehicle or a driver of the vehicle.

15. The apparatus of claim 14 further comprising a display for use within the vehicle and wherein the communicating comprises displaying on the display.

16. The apparatus of claim 15 wherein the apparatus comprises an interface for communicating with the vehicle.

17. The apparatus of claim 15 wherein the apparatus is integrated into the vehicle.

18. The apparatus of claim 14 wherein the decision support system is implemented by the computing device.

19. The apparatus of claim 14 wherein the decision support system is implemented at a server platform in operative communication with the computing device.

20. A method for providing freight and weather decision support, the method comprising:
receiving data input from a plurality of sources wherein the data input comprises weather data and route data for a freight carrying vehicle and wherein the weather data includes weather data from a sensor of at least one other freight carrying vehicle;
applying the data input within a decision support system implemented by a computing system to determine an evidence-based probability of risk of delay and crash for the freight carrying vehicle; and
communicating a decision based on the evidence-based probability of risk of delay and crash to the vehicle or a driver of the vehicle.
